(19) United States
(12) Patent Application Publication
(10) Pub. No.: US 2006/0059263 A1
(43) Pub. Date: Mar. 16, 2006

(54) Optimizing scaleable video algorithm asset distribution utilizing quality indicators

(75) Inventors: Christian Hentschel, Cottbus (DE); Robertus Hendricus Maria Wubben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/544,200

(22) PCT Filed: Jan. 27, 2004
(86) PCT No.: PCT/IB04/00241

§ 371 Date: Aug. 2, 2005

Related U.S. Application Data
(60) Provisional application No. 60/445,373, filed on Feb. 6, 2003.

(51) Int. Cl. G06F 15/173

(52) U.S. Cl. 709/226

(57) ABSTRACT

A method is directed to controlling asset allocation of a consumer terminal. The method provides for receiving input data into at least one scalable media algorithm, processing the input data through at least one scalable media algorithm, and determining at least one quality indicator value, for an amount of data processed, associated with the scalable media algorithm based on the processing for each scalable media algorithm. The method may further include distributing assets to the algorithm based on the quality indicator value. The step of determining the quality indicator value may include analyzing the amount of processing and processed data, determining a class based on the analyzed amount of processing and processed data, and assigning at least one quality indicator value based on the determined class. The step of determining the quality indicator value may be based on the amount of processing and processed data.

### CROSS REFERENCE TO RELATED APPLICATION

This application claims the benefit of U.S. provisional application Ser. No. 60/445,373 filed Feb. 6, 2002, which is incorporated herein by reference.

In general, the invention relates to Scaleable Video Algorithms (SVAs). More specifically, the invention relates to a method and system for optimizing SVA asset distribution.

Future consumer terminals such as, TV sets, set-top boxes (STBs), and displays combine high-quality video and audio with applications from the mainstream multimedia domain as found on personal computers (PCs).

Future consumer terminals will be based on programmable platforms instead of dedicated hardware. Execution of video algorithms on programmable platforms is limited by the available resources. Recently, scaleable algorithms and run-time control of output quality and resource usage have been utilized to overcome such limitations, such as, for example SVAs including MPEG-2 decoding and imaging enhancements and Quality-of-Service (QoS) control software.

Scaleable algorithms can use programmable components in a cost-effective manner. An SVA is an algorithm that allows the dynamic adaptation of output quality versus resource usage on a given platform. Traditional systems do not support such dynamic control of the resources and change of quality levels of an algorithm. Software solutions must also result in stable, robust, predictable, and cost-effective systems. Therefore, a QoS environment must include dynamic resource management.

An SVA supports different platforms/product families for media processing and is easily controllable by a control device for several predefined settings. SVAs with irregular priority processing start with the most important image parts and process data in decreasing order of importance. SVAs can be regulated or interrupted to meet resource limitations. Therefore, these SVAs are inherently data dependant with varying output quality.

SVAs can be designed to allow for different quality levels in exchange for the required processing resources. In a dynamic environment with scaleable algorithms, the system optimization has to take both resources and quality into account. Lacking proper information leads to suboptimal results. The lack of useful quality information is a bottleneck in dynamic resource controlled systems.

It would be desirable, therefore, to provide a method and system that would overcome these and other disadvantages.

One aspect of the invention provides a method for controlling asset allocation of a consumer terminal by receiving input data into at least one scalable media algorithm, processing the input data through at least one scalable media algorithm, and determining at least one quality indicator value associated with each scalable media algorithm based on the processing for each scalable media algorithm.

In accordance with another aspect of the invention, a computer readable medium storing a computer program includes: computer readable code for receiving input data into at least one scalable media algorithm; computer readable code for processing the input data through at least one scalable media algorithm; and computer readable code for determining at least one quality indicator value associated with each scalable media algorithm based on the processing for each scalable media algorithm.

In accordance with yet another aspect of the invention, a system for controlling asset allocation of a consumer terminal is provided. The system includes means for receiving input data into at least one scalable media algorithm. The system further includes means for processing the input data through at least one scalable media algorithm. Means for determining at least one quality indicator value associated with each scalable media algorithm based on the processing for each scalable media algorithm is also provided.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

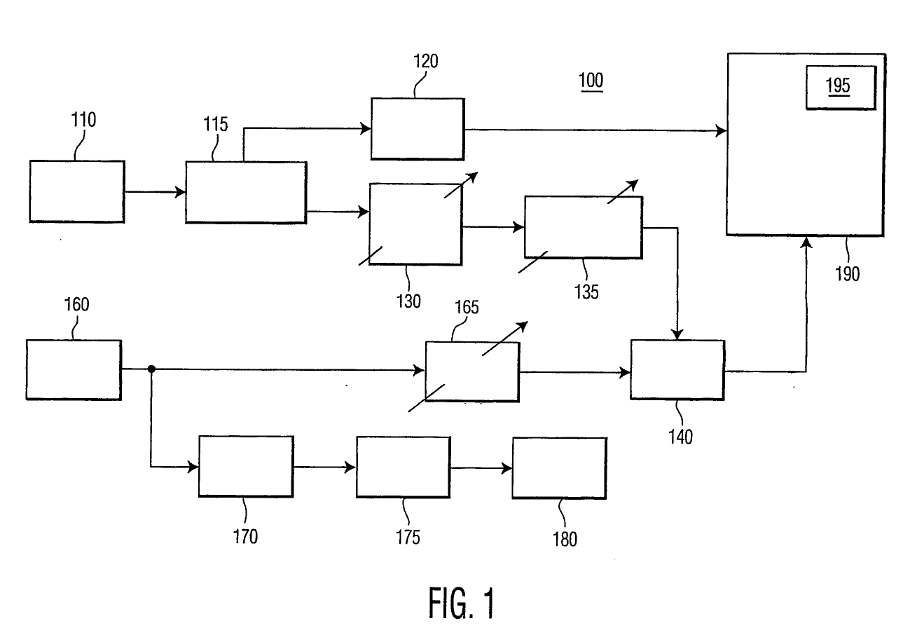

FIG. 1 is a block diagram illustrating an operating environment in accordance with the present invention;

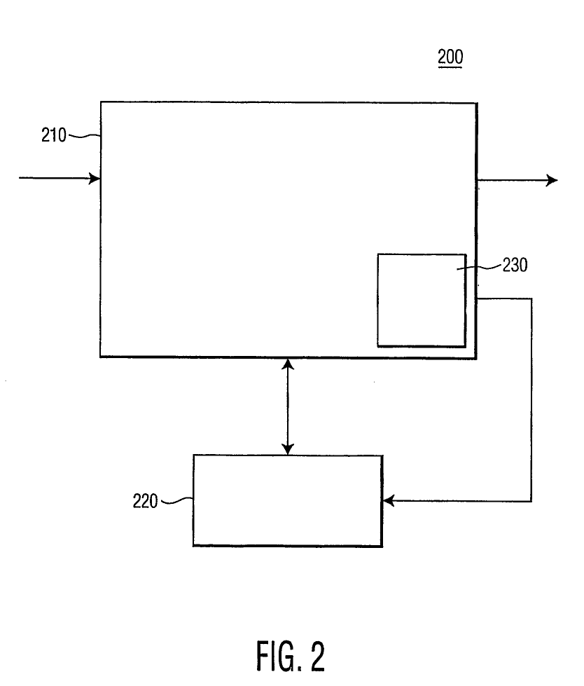

FIG. 2 is a block diagram illustrating a control system in accordance with the present invention;

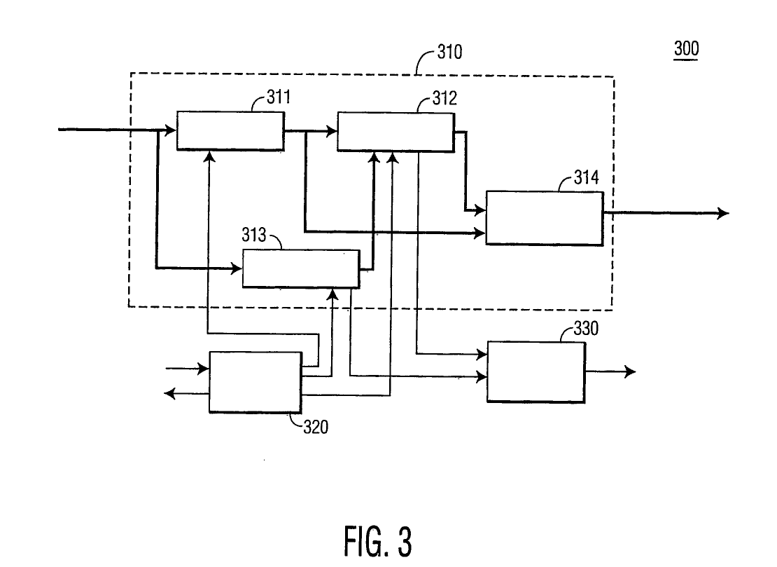

FIG. 3 is a block diagram illustrating a scalable algorithm with quality indicator output in accordance with the present invention; and

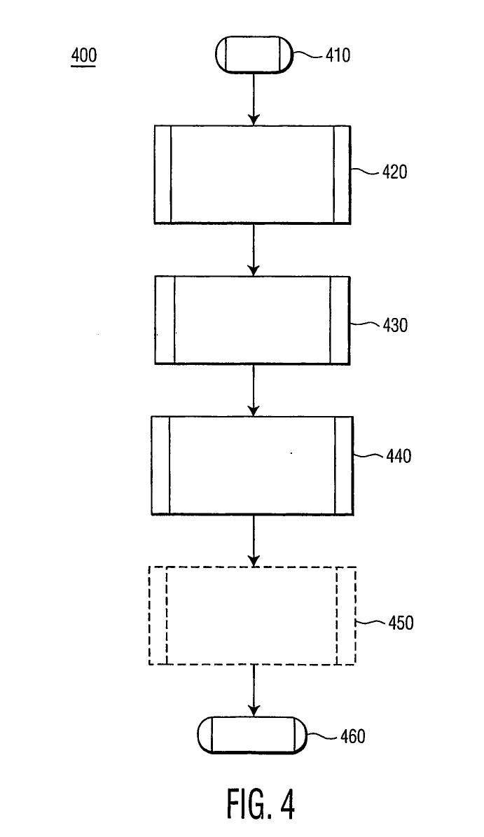

FIG. 4 is a flow diagram depicting an exemplary embodiment of code on a computer readable medium in accordance with the present invention.

FIG. 1 is a block diagram illustrating an operating environment in accordance with the present invention. In FIG. 1, system 100 includes scaleable and non-scaleable algorithms that run concurrently on a programmable processor and coprocessors (not shown). Scalable algorithms include MPEG video decoder 130, sharpness enhancement 135, and software Scaler 165. The software Scaler 165 provides down-scaling for picture-in-picture application. Non-scaleable algorithms include Demultiplexer 115, audio decoder 120, software mixer 140, hardware scaler 170, and MPEG encoder 175. Scalable algorithms are scalable media algorithms (SMA) that can be implemented as video (SVA), graphics (SGA), or audio (SAA) applications 180

In operation, available system assets are distributed to the non-scaleable algorithms based on set requirements. Assets include resources such as CPU cycles, coprocessor cycles, memory, bus bandwidth, time, and the like. Typically, once the available assets are distributed to the non-scaleable algorithms then remaining assets are distributed to the scaleable algorithms. In one embodiment, the remaining assets are distributed to the scaleable algorithms based on the amount of assets available and the number and type of scaleable algorithms that are operating.

In an example, DVD unit 110 is the only device operating. After assets are allocated to Demultiplexer 115, audio decoder 120, and software mixer 140 the remaining assets are allocated to the two scaleable algorithms MPEG video decoder 130 and sharpness enhancement 135.

Throughout the operation of system 100 additional assets, such as assets unused after initial allocation, may be available for allocating to scaleable algorithms. In one embodiment, additional assets are allocated in a predetermined manner, such as, for example based on an asset allocation table.

In this example, when analog video unit 160 is introduced to the system, such as the use of an analog video unit 160 in conjunction with a picture-in-picture function 195 of display 190, additional non-scaleable algorithms will require asset allocation in addition to scaleable algorithm software Scaler 165. The increase in asset demand will require reassessment of assets assigned to scaleable algorithms MPEG video decoder 130 and sharpness enhancement 135.

FIG. 2 is a block diagram illustrating a control system 200 in accordance with the present invention. FIG. 2 includes scaleable video algorithm (SVA) 210, including priority processing, coupled to a system controller unit 220. SVAs including priority processing start processing with the most important image parts and process data in a decreasing order of importance. SVAs with priority processing can be regulated or interrupted to meet system allocation requirements. Therefore, SVAs with priority processing are inherently data dependant. Additionally, the resulting output quality is usually not a function of the assets (resources) used for processing.

Scaleable video algorithm (SVA) 210 further includes a quality indicator unit 230 that is also coupled to the system controller unit 220. In one embodiment and referring to FIG. 1 above, SVA 210 is implemented as any of the SVAs, such as, for example MPEG video decoder 130, sharpness enhancement 135, or software Scaler 165. Quality indicator unit 230 is a software component that produces at least one quality indicator value based on the amount and type of processing SVA 210 completes.

In operation, SVA 210 receives an asset allocation, also referred to as a budget from system controller 220 based on system requirements. SVA 210 also receives input data and processes the received input data into output data based on the amount of assets allocated. Quality indicator unit 230 analyzes the amount of processing, determines a class based on the analyzed amount of processing, and assigns the quality indicator value based on the determined class.

In one embodiment, quality indicator unit 230 produces multiple quality indicator values based on different criteria. Quality indicator unit 230 transmits the quality indicator values to system controller 220. System controller 220 optimizes system assets based on the quality indicator values.

Such a quality indicator is described for scalable motion estimation. Imagine, motion estimation entails establishing a block size including a specified grain detail for processing an entire frame. The process envisions starting with a large block size and course grain and processing the entire frame. In one embodiment, if enough processing is available the block size can be decreased and the grain detail accuracy increased to determine a processing level.

A quality indicator value is determined by analyzing the smallest block size and finest grain processed. Ending the processing with a large block size or course grain detail indicates a lower quality of processing than ending the processing with a smaller block size or finer grain detail. In one embodiment, the combination of block size and grain detail is utilized to determine a class and the class is utilized to determine a quality indicator value. In another embodiment, the combination of block size and data dependant matching error is utilized to determine a class and the class is utilized to determine a quality indicator value. The quality indicator value is then transmitted to the system controller 220 for use in asset allocation.

Another quality indicator is described for noise reduction. Noise reduction entails analyzing picture content in classes, such as, for example flat unstructured regions (class 1), edges and edge directions (class 2), and textured areas (class 3). The classes indicate a descending amount of impact on the visibility of noise. That is, flat unstructured regions (class 1) contribute the most to the visibility of noise while textured areas (class 3) contribute the least. In one embodiment, a noise level estimator can be utilized to distinguish between the different classes.

A quality indicator value is determined based on the class processed with the available asset allocation. The higher the class processed, the larger the quality indicator value. Quality indicator values are then transmitted to the system controller 220 for use in asset allocation. In one embodiment, the system controller analyzes the received quality indicator values and the available assets and reallocates assets based on the information. In this embodiment, the system controller determines SVAs that will receive additional assets and SVAs that will receive less assets based on which asset distribution will maximize the overall output quality.

In another embodiment, system controller 220 determines desired quality levels and transmits the quality levels to each SVA. In this embodiment, each SVA determines the amount of assets required to fulfill the quality level requirement and transmits the asset requirement to the system controller 220. In this embodiment, when system controller 220 receives the asset requirements it can then optimize the system.

In an example, the system controller 220 optimizes the system 200 by determining the amount of unallocated assets and further determining the number of quality indicators for the SVAs that can be increased based on the amount of assets available. In this example, the system controller 220 optimizes the system 200 by increasing specific quality indicators or the amount of assets allocated to certain SVAs based on the determination. Alternatively, system controller 220 may optimize system 200 by decreasing specific quality indicators or the amount of assets allocated to certain SVAs based on the determination.

FIG. 3 is a block diagram illustrating a scalable algorithm with quality indicator output in accordance with the present invention. In FIG. 3, scalable media algorithm 300 includes scalable media processor 310 that is coupled to a quality control 320 and a quality indicator 330. In one embodiment and referring to FIG. 3, scalable media processor 310 includes functions (311-314).

Scalable media processor 310 receives input data, in the form of a signal, and processes the received data into output data, in the form of a signal, based on one or more control signals received from quality control 320. Scalable media processor 310 produces additional information that is transmitted to the quality indicator 330.

In one embodiment, scalable media processor 310 is implemented as a scalable video algorithm (SVA). In other embodiments, scalable media processor 310 is implemented as a scalable graphics algorithm (SGA) or a scalable audio algorithm (SAA).

In an example, scalable media processor 310 is implemented as a scalable video algorithm (SVA) producing a quality indicator value for scalable motion estimation, described above. In another example, scalable media processor 310 is implemented as a scalable video algorithm (SVA) producing a quality indicator value for noise reduction, described above.

Functions (311-314) conduct the actual processing of the input data scalable media processor 310 receives. Functions (311-314) may be implemented as scalable or non-scalable functions. In one embodiment and referring to FIG. 3, Functions 1-3 (311-313) are scalable functions and receive control signals from quality control 320. In this embodiment, Functions 2 and 3 (312 and 313) provide information to quality control 320 such as, for example class information, error information, and the like. The provided information enables quality control 320 to determine a quality indicator value defining the scalable media processor 310 processing quality.

FIG. 4 is a flow diagram depicting an exemplary embodiment of code on a computer readable medium in accordance with the present invention. FIG. 4 details an embodiment of a method 400 for controlling asset allocation of a consumer terminal. Method 400 may utilize one or more systems detailed in FIGS. 1-3, above.

Method 400 begins at block 410 where a system determines a requirement to control asset allocation. In one embodiment, the system is implemented as system 100 in FIG. 1 above. Method 400 then advances to block 420.

At block 420, the system receives input data. The system may be implemented as a consumer terminal, a set-top box (STB), a TV set, a video display, and the like. In one embodiment and referring to FIG. 1 above, system 100 receives input data from DVD unit 110. Method 400 then advances to block 430.

At block 430, the system processes the input data through Scaleable Media Algorithms (SMAs). In one embodiment, the scalable media algorithm is implemented as a scalable video algorithm (SVA). In other embodiments, the scalable media algorithm is implemented as a scalable graphics algorithm (SGA) or a scalable audio algorithm (SAA). In yet another embodiment, the processing is priority processing.

In one example and referring to FIG. 1 above, the SVAs are implemented as any of the SVAs, such as, for example MPEG video decoder 130, sharpness enhancement 135, or software Scaler 165. In another example and referring to FIGS. 2 and 3 above, the SVAs function substantially similar to SVA 210 or SMA 300. That is, the SVAs each receive an asset allocation, also referred to as a budget, from the system controller based on system requirements. Each SVA also receives input data and processes the received input data into output data based on the amount of assets allocated. Method 400 then advances to block 440.

At block 440, the system determines quality indicator values associated with SVAs based on the processing. In one embodiment, the system determines quality indicator values associated with SVAs based on the amount of processing. In another embodiment, the system determines quality indicator values associated with SVAs based on the amount of processed data. In yet another embodiment, the system determines quality indicator values associated with SVAs based on the amount of processing and processed data.

In one embodiment and referring to FIG. 2, quality indicator values are determined by a quality indicator unit that produces multiple indicator values based on specified criteria. In an example, the quality indicator for motion estimation includes specified criteria as detailed in FIG. 2 above. In another example, the quality indicator noise reduction includes specified criteria as detailed in FIG. 2 above. The quality indicator values are then transmitted to the system controller. Method 400 then advances to optional block 450.

At optional block 450, the system distributes assets based on the received quality indicator values. Block 450 is included to detail system functionality. In one embodiment, system assets are distributed as described in FIG. 2 above. Method 400 then advances to block 460 where it returns to monitoring the system for asset use changes.

Alternatively, method 400 may continue to determine quality indicator values and reallocate assets. In one embodiment, this process includes processing the input signal through the scalable video algorithms based on the distributed assets, and determining at least one new quality indicator value associated with each scalable video algorithm based on the amount of processing and processed data for each scalable video algorithm. Assets can then be redistributed to each algorithm based on the new quality indicator values.

In another embodiment, method 400 is implemented so that the system starts by determining quality levels for the SVAs. In this embodiment, the SVAs provide asset requirements and the system optimizes the resource usage based on the remaining assets after the asset allocation.

In an example, method 400 provides at least one predetermined quality level for a plurality of scalable video algorithms and allocates assets to each scalable video algorithm based on the predetermined quality level. Additionally, the system can determine additional asset availability based on the allocation and reallocate assets based on the determination. In this embodiment, the predetermined quality level can be based on a user defined input. In an example, the user defined input is received via a user interface.

In yet another embodiment, a regulator can be implemented to further control the asset allocation. In one embodiment, the regulator is implemented to control signal output quality. In this embodiment, the regulator controls quality to insure signal output quality remains within predetermined levels, on average, over time.

In another embodiment, the regulator is implemented as a resource regulator. In this embodiment, the regulator controls processing to insure processing resources remain within predetermined levels, on average, over time.

The above-described methods and implementation for controlling asset allocation of a consumer terminal are example methods and implementations. These methods and implementations illustrate one possible approach for controlling asset allocation of a consumer terminal. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

The present invention relates to the field of image display systems; more specifically, it relates to a method and system for controlling the contrast of pixels in a displayed image.

1. A method for controlling asset allocation of a consumer terminal, the method comprising:
receiving input data into at least one scalable media algorithm;
processing the input data through at least one scalable media algorithm; and
determining at least one quality indicator value, for an amount of data processed, associated with the scalable media algorithm based on the processing for the scalable media algorithm.

2. The method of claim 1, further comprising:
distributing assets to the algorithm based on the quality indicator values.

3. The method of claim 1, wherein determining at least one quality indicator value associated with the scalable media algorithm is based on the amount of processing and processed data.

4. The method of claim 1, wherein the processing is priority processing.

5. The method of claim 1, wherein determining the quality indicator value comprises:
analyzing the amount of processing and processed data;
determining a class based on the analyzed amount of processing and processed data; and
assigning at least one quality indicator value based on the determined class.

6. The method of claim 2, further comprising:
processing the input data through the scalable media algorithms based on the distributed assets;
determining at least one new quality indicator value associated with each scalable media algorithm based on the processing for each scalable media algorithm; and
redistributing assets to each algorithm based on the new quality indicator value.

7. The method of claim 1, further comprising:
providing at least one predetermined quality level for a plurality of scalable media algorithms; and
allocating assets to each scalable media algorithm based on the predetermined quality level.

8. The method of claim 7, wherein the predetermined quality level is based on a user defined input.

9. The method of claim 1, wherein the scalable media algorithm is selected from a group consisting of: a scalable video algorithm, a scalable graphics algorithm, and scalable audio algorithm.

10. A computer readable medium storing a computer program comprising:
computer readable code for receiving input data into at least one scalable media algorithm;
computer readable code for processing the input data through at least one scalable media algorithm; and
computer readable code for determining at least one quality indicator value, for an amount of data processed, associated with each scalable media algorithm based on the processing for the scalable media algorithm.

11. The computer readable medium of claim 10, further comprising:
computer readable code for distributing assets to the algorithm based on the quality indicator values.

12. The computer readable medium of claim 10, wherein the computer readable code for determining at least one quality indicator value associated with the scalable media algorithm is based on the amount of processing and processed data.

13. The computer readable medium of claim 10, wherein the processing is priority processing.

14. The computer readable medium of claim 10, wherein the computer readable code for determining the quality indicator value comprises:
computer readable code for analyzing the amount of processing and processed data;
computer readable code for determining a class based on the analyzed amount of processing and processed data; and
computer readable code for assigning at least one quality indicator value based on the determined class.

15. The computer readable medium of claim 11, further comprising:
computer readable code for processing the input data through the scalable video algorithms based on the distributed assets;
computer readable code for determining at least one new quality indicator value associated with each scalable video algorithm based on the processing for each scalable video algorithm; and
computer readable code for redistributing assets to each algorithm based on the new quality indicator value.

16. The computer readable medium of claim 10, further comprising:
computer readable code for providing at least one predetermined quality level for a plurality of scalable media algorithms; and
computer readable code for allocating assets to each scalable media algorithm based on the predetermined quality level.

17. The computer readable medium of claim 16, wherein the predetermined quality level is based on a user defined input.

18. The computer readable medium of claim 10, wherein the scalable media algorithm is selected from a group consisting of: a scalable video algorithm, a scalable graphics algorithm, and scalable audio algorithm.

19. A system for controlling asset allocation of a consumer terminal, the system comprising:
means for receiving input data into at least one scalable media algorithm;
means for processing the input data through at least one scalable media algorithm; and
means for determining at least one quality indicator value, for an amount of data processed, associated with each scalable media algorithm based on the processing for each scalable media algorithm.

20. The system of claim 19, further comprising:
means for distributing assets to the algorithm based on the quality indicator value.
